(19) United States
(12) Patent Application Publication
(10) Pub. No.: US 2012/0103906 A1
(43) Pub. Date: May 3, 2012

(54) Closed Circuit Desalination Retrofit For Improved Performance Of Common Reverse Osmosis Systems

(75) Inventor: Avi Efraty, Har Adar (JP)

(73) Assignee: Desalitech Ltd., Har Adar (IL)

(21) Appl. No.: 13/381,960

(22) PCT Filed: Jul. 5, 2010
(86) PCT No.: PCT/IL10/00537

§ 371 Date: Jan. 2, 2012

(30) Foreign Application Priority Data
Jul. 5, 2009 (IL) 199700

(51) Int. Cl. C02F 1/44

(52) U.S. Cl. 210/652; 210/198.1

(57) ABSTRACT

The retrofit technology utilizes pressurized brine of convention RO to feed a Closed Circuit Desalination (CCD) unit; wherein, further desalination takes place to a desired recovery level. The application exemplified in FIG. 4 is of a retrofit unit comprising a Booster Pump (BP2) for raising pressure of inlet feed; a Circulation Pump (CP) for creating cross flow over membranes (E) in the pressure vessel (M), thereby enable efficient RO desalination; an Actuated Valve (AV) in line with a partially open Manual Valve (MV) to enable periodic replacement of high salinity concentrates with fresh feed without stopping desalination; No Return (NR) valve means to control the direction of flow in the system; and monitoring means such as of electric conductivity (CM) and flow (FM). Periodic replacement of high salinity concentrates by fresh feed initiated at desired high system electric conductivity and terminated at a desired low system electric conductivity, while desalination continued.

### BACKGROUND OF THE INVENTION

The present invention relates to a Closed Circuit Desalination Retrofit (CCDR) apparatus for improved performance of common Reverse Osmosis (RO) systems.

### DESCRIPTION OF PRIOR ART

Closed Circuit Desalination (CCD) is a non conventional RO technology first reported in the late eighties by Szuz et al. in U.S. Pat. No. 4,983,301 and by Bartt in U.S. Pat. No. 4,814,086 to take place continuously by means of two side Tanks. Recently, a continuous CCD technology with a single container was reported in the PCT publication WO 2005/016830 00 A2, and more recently, a continuous CCD process without need of containers was reported in the PCT publication WO 2006/001007 A2.

Some common Brackish Water Reverse Osmosis (BWRO) applications, such as production of low salinity permeates for medical dialysis, are performed intentionally with low recovery at considerable waste of water and energy. The present invention describes a unique Closed Circuit Desalination Retrofit (CCDR) apparatus intended for facile integration with common BWRO systems for their improved performance.

### SUMMARY OF THE INVENTION

The present invention describes a novel CCDR unit fed by pressurized brine effluent (henceforth “pressurized feed”) received from a Common BWRO system which performs a continuous two-step consecutive sequential desalination process; with first-step experienced most time involving Closed Circuit Desalination (CCD) of recycled concentrate mixed with fresh pressurized feed through one membrane module, or more than one membrane modules with respective inlets and outlets connected in parallel; with a second-step involving a Plug Flow Desalination (PFD) process whereby brine in the closed circuit is replaced with fresh pressurized feed at a desired recovery level; and with permeate produced by the integrated CCDR unit either recycled to inlet of the common BWRO system or adds to its permeate production. If feed pressure at the inlet to the CCDR unit is insufficient, a booster pump at inlet to said unit may enable the reaching of an appropriate pressure for a desired desalination recovery level.

The integration of a common BWRO unit with the inventive CCDR unit achieved by means of a conducting line for pressurized brine effluent from the outlet of the former to the inlet of the latter and a conducting line for permeate from the latter to the inlet feed line of the former or, alternatively, a conducting line for combining the produced permeate of the latter and the former together.

The inventive integrated BWRO-CCDR system enables enhanced feed source recovery concomitant with improved permeate quality and reduced energy demand.

### BRIEF DESCRIPTION OF THE DRAWINGS

FIG. 1 is a schematic flow diagram showing the integration of BWRO and CCDR units in a system for high quality permeates

FIG. 2 is a schematic flow diagram showing the integration of BWRO and CCDR units in a system for high desalination recovery.

FIG. 3 is a schematic diagram of a CCDR unit during a closed circuit desalination mode of operation.

FIG. 4 is a schematic diagram of a CCDR unit with a permeate pressure booster pump during a closed circuit desalination mode of operation.

FIG. 5 is a schematic diagram of a CCDR unit with a feed pressure booster pump during a closed circuit desalination mode of operation.

FIG. 6 is a schematic diagram of a CCDR unit with both a permeate pressure booster pump and a feed pressure booster pumps during a closed circuit desalination mode of operation.

### DETAILED DESCRIPTION OF THE INVENTION

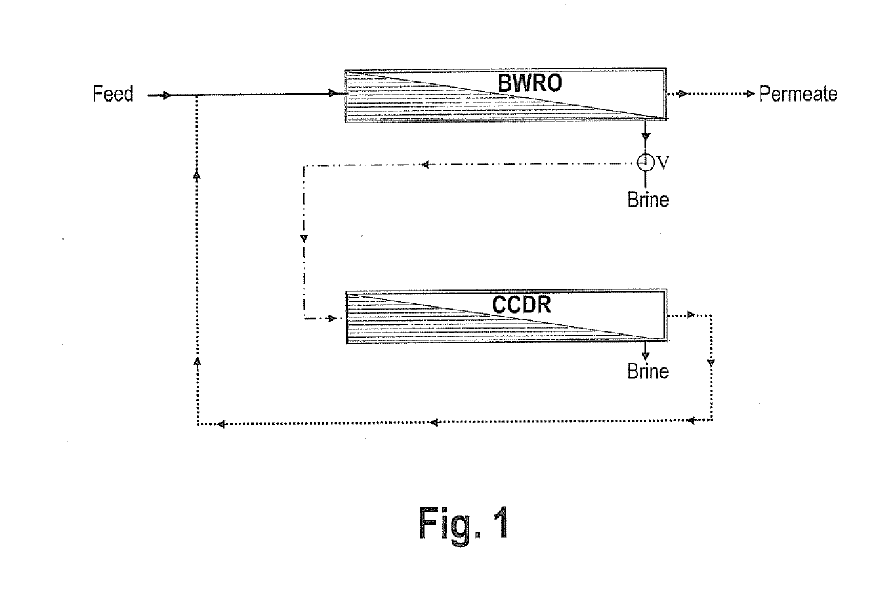

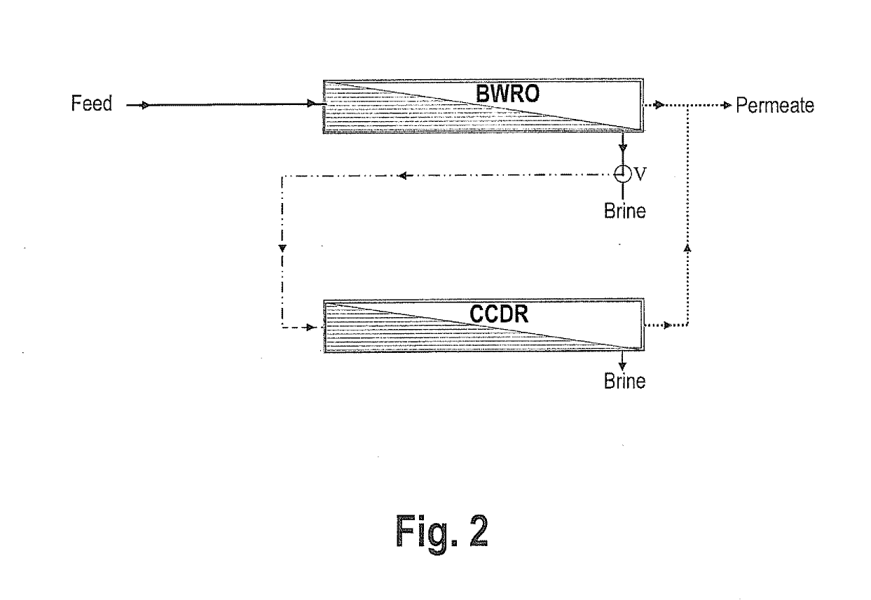

The inventive systems depicted in FIG. 1 and FIG. 2 propose the adding of a Closed Circuit Desalination Retrofit (CCDR) unit to a common Reverse Osmosis Brackish Water (BWRO) unit in an integrated system for increased recovery and improved quality of permeates. The CCDR and BWRO units in the system depicted in FIG. 1 are linked together by conducting lines such that the pressurized brine of the latter becomes the feed to the former and the permeate of the former becomes part of the feed to the latter. The inventive system depicted in FIG. 2 differs from that in FIG. 1 in some of its permeate conducting lines, since in the former system (FIG. 2) permeates of the CCDR and BWRO units are combined; whereas, in the latter system (FIG. 1) the permeate of the CCDR unit becomes part of the feed to the BWRO unit. Both inventive systems displayed in FIG. 1 and FIG. 2 allow the attainment of high desalination recovery, with the former system (FIG. 1) intended particularly for production of high quality permeates and with the latter system (FIG. 2) intended to serve as a multi stage recovery booster for existing BWRO systems of poor desalination recovery.

The integrated BWRO-CCDR systems described in FIG. 1 and FIG. 2 comprise any common BWRO unit of prior art coupled with the inventive CCDR unit by means of the indicated conducting lines. The claims of the present invention are made specifically with regards to the new CCDR unit and its integration with a common BWRO unit into a system of greatly improved performance as compared with that of the latter. Accordingly, the core of the invention relates to systems wherein a CCDR unit receives pressurized feed from a common BWRO unit with permeate produced by the CCDR unit either recycled as part of the feed to the BWRO unit according to the system depicted in FIG. 1 or, alternatively, combined with the permeate produced by the BWRO unit according to the system depicted in FIG. 2. The CCDR units in the systems depicted in FIG. 1 and FIG. 2 perform most of the time on the basis of Closed Circuit Desalination (CCD) principles with flow rates of pressurized feed and permeate being the same (100% recovery); and part of the time on the basis of Plug Flow Desalination (PFD) principles to enable the rejection of brine effluent from the close circuit of the CCDR unit and its replacement with fresh pressurized feed while desalination is continued at a reduced desalination recovery. Compared with the performance of an isolated BWRO unit, the integrated systems described in FIG. 1 and FIG. 2 enable higher feed source recovery, improved quality permeates and significant savings in energy since the pressurized brine flow from the BWRO unit becomes the principle energy source of the CCDR units.

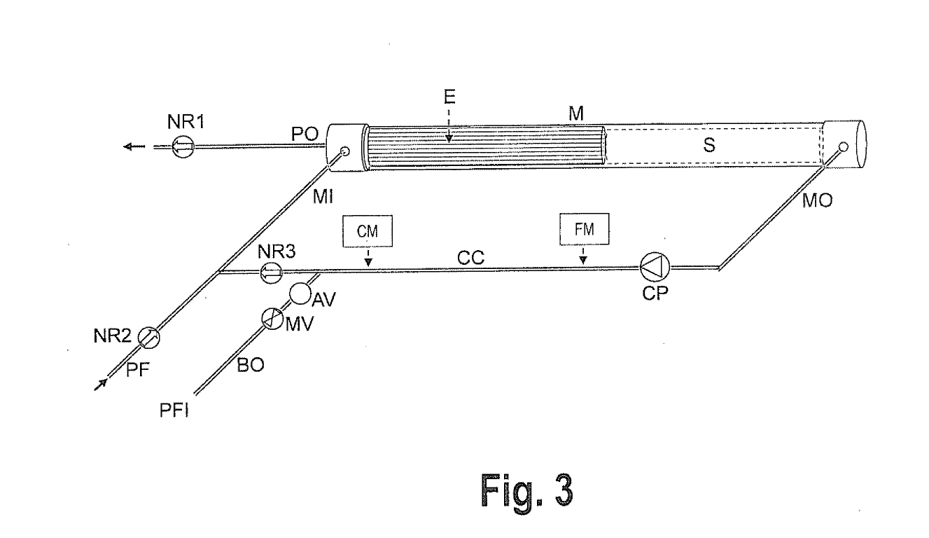

The CCDR unit of the embodiment displayed in FIG. 3 comprises a single module (M) with one membrane element (E) and one element spacer (S), a circulation pump (CP) for the recycling of pressurized concentrate from module outlet (MO) to module inlet (MI) through a closed circuit conduit (CC), a pressurized feed (PF) conduit for admitting fresh pressurized feed to the closed circuit via a feed inlet (PFI) positioned upstream of the module inlet (MI), a no-return valve means (NR1, NR2 and NR3) to maintain the desired flow direction in the various parts of the unit, an actuated two-way valve means (AV) to enable occasional replacement of brine effluent with fresh feed in said closed circuit, a manual valve means (MV) to enable the attainment of a desired pressure drop in said closed circuit of the CCDR unit while AV is opened for brine release, a monitoring means such as a flow meter (FM) and an electric conductivity meter (CM) of recycled concentrate, and control means to enable the automated actuation of said CCDR unit effectively and efficiently at a desired desalination recovery level. The principle functions of the CP in the preferred embodiment (FIG. 3) are to offset the pressure drop between module inlet and outlet as well as to enable control over membrane cross flow in order to minimize adverse effects of concentration polarization.

The CCDR unit of the integrated systems depicted in FIG. 1 and FIG. 2 is of the preferred embodiment displayed in FIG. 3 for application in cases where the feed flow of pressurized brine received from the BWRO unit is of sufficient pressure to enable the attainment of a desired recovery level. The preferred embodiment in FIG. 3 assumes permeate production and delivery at near atmospheric pressure without need for pressure booster means

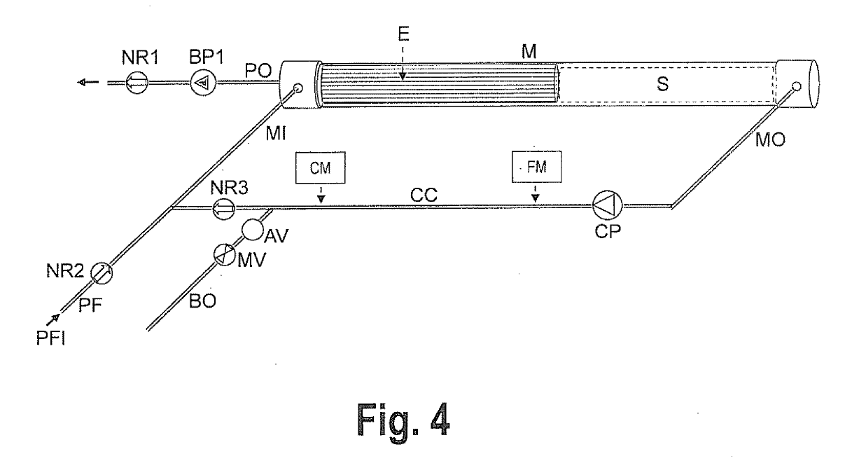

The CCDR unit of the integrated system depicted in FIG. 1 is of the preferred embodiment displayed in FIG. 4 for application in cases where the feed supplied to the BWRO unit of said system is under mild pressure (e.g., 2-5 bar). The purpose of the installed booster pump (BP1) on the permeate outlet conduit (PO) of said CCDR unit (FIG. 4) is to raise permeate pressure to the desired inlet pressure of the BWRO unit of the system displayed FIG. 1.

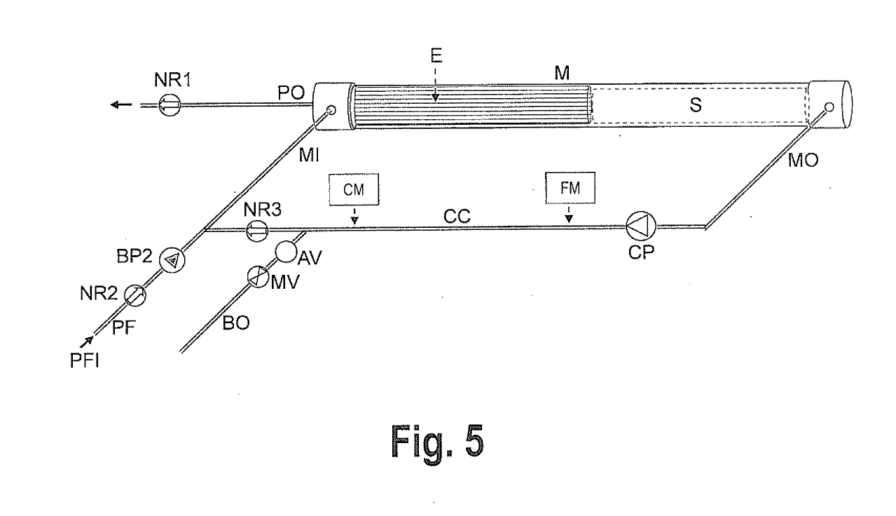

The CCDR unit of the integrated systems depicted in FIG. 1 and FIG. 2 is of the preferred embodiment displayed in FIG. 5 for application in cases where the feed flow of pressurized brine received from the BWRO unit is of insufficient pressure to enable the attainment of a desired recovery level; therefore, pressure booster means required (BP2). The preferred embodiment in FIG. 5 assumes permeate production and delivery at near atmospheric pressure without need for permeate pressure booster means

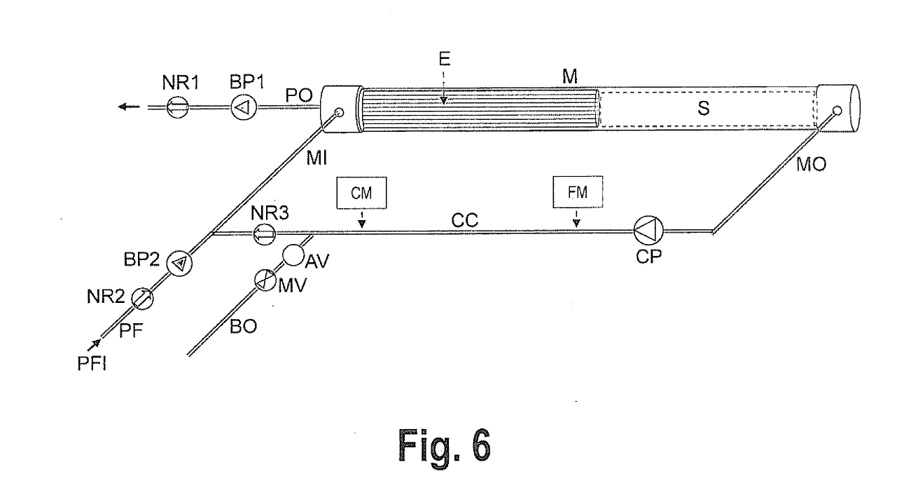

The CCDR unit of the integrated system depicted in FIG. 1 is of the preferred embodiment displayed in FIG. 6 for application in cases where the feed pressure to said unit and the permeate pressure from said unit need to be raised by a pressure booster means (BP2 and BP1, respectively).

The method of operation of the integrated systems displayed in FIG. 1-FIG. 2 proceeds as followed: The pressurized brine flow from the common SWRO unit is fully diverted to the inlet of the CCDR unit by the valve means V, an operation whereby all the functions in the latter unit are activated. Conversely, the stopping of pressurize brine flow into the CCDR unit by the valve means V terminates the operation of this unit automatically. The CCDR units (FIG. 3-FIG. 6) of the integrated systems displayed in FIG. 1-FIG. 2 experience most of the time a closed circuit desalination mode of operation of 100% recovery with feed flow (Q_{feed}) and permeate flow (Qₚₑᵣₘₑₐₜₑ) being the same (Q_{feed}=Qₚₑᵣₘₑₐₜₑ) and this mode is proceeded by a brief step of plug flow desalination (Q_{feed}=Qₚₑᵣₘₑₐₜₑ+Q_{brine}) whereby brine in the closed circuit is replaced by fresh pressurized feed at a reduced desalination recovery, Brine rejection from the closed circuit of the CCDR unit takes place by the occasional opening of valve AV when the conductivity the recycled concentrate reaches a fixed predefined high value which manifests the attainment of a desired recovery and the closure of this valve will be proceeded at a fixed predefined low conductivity value which manifests the complete replacement of rejected brine with fresh pressurized feed. Accordingly, the actuation of valve AV is fully controlled from the monitored conductivity (CM) of the recycled concentrate and its high and low predefined set points.

The inventive CCDR units of the preferred embodiments in FIG. 3-FIG. 6 of the integrated systems displayed in FIG. 1-FIG. 2 are none autonomous since fully rely on pressurized feed supplied from the BWRO units of the systems. Accordingly, the new inventive method implicates common BWRO units as the pressurized feed source to CCDR units which perform a two-step consecutive sequential process with a closed circuit desalination mode of operation of 100% recovery experienced most of the time and with brief intervals plug flow desalination of reduced recovery taking place occasionally for the discharge of brine from the closed circuit and its replacement with fresh pressurized feed which is the brine effluent of the BWRO units. In simple terms, the inventive method may be view as the integration between a single stage BWRO unit and a CCDR unit of multistage desalination capability for the attainment of high recovery with energy efficiency. The CCDR units and the integrated systems of the present invention suggest an effective approach for the upgrade of existing inefficient BWRO systems.

It will be understood that the design of the preferred embodiments of the inventive units, apparatus and method displayed in FIG. 1-FIG. 6 are schematic and simplified and are not to be regarded as limiting the invention. In practice, the desalination units and apparatus according to the invention may comprise many additional lines, branches, valves, and other installations and devices as necessary according to specific requirements while still remaining within the scope of the inventions and claims.

The preferred embodiments depicted in FIG. 3-FIG. 6 display a single module unit apparatus with a single membrane element and a spacer and this for the purpose of simplicity, clarity, uniformity and the convenience of presentation. It will be understood that the general design according to the invention is neither limited nor confined to single module apparatus and/or to apparatus with just one membrane element per module. Specifically, it will be understood that CCDR units of the inventive apparatus and method may comprise more than one module with inlets and outlets of modules connected in parallel to the closed circuit conducting line and that each of the modules may comprise one or more than one membrane element with or without spacers.

Concentrate recycling through the closed circuit of the inventive unit displayed in FIG. 3-FIG. 6 is done by circulation systems. It will be understood that the circulation systems according to the invention may comprise a single circulation pump, or instead, several circulation pumps, applied simultaneously in parallel and/or in series.

It will be obvious to those versed in the art that the inventive desalination method may be operated with modular units and/or non-modular desalination apparatus of different designs, as already explained hereinabove in respect of the inventive apparatus and/or units, as long as such apparatus and/or units comprise a closed circuit of conducting line with one module or more than one module with their inlets and outlets connected in parallel to the closed circuit with each module containing one membrane element or more than one membrane elements; circulation systems; pressurized feed conducting lines with or without pressure booster pumps; permeate collection lines; valves means positioned in the closed circuit conducting line for brine discharge; brine removal lines; monitoring devices of pressure, flow, and conductivity; and control means whereby the entire system is operated continuously.

While the invention has been described hereinabove in respect to particular embodiments, it will be obvious to those versed in the art that changes and modifications may be made without departing from this invention in its broader aspects, therefore, the appended claims are to encompass within their scope all such changes and modifications as fall within the true spirit of the invention.

It will be obvious to skilled in the art of reverse osmosis that the inventive systems, units and method can apply in general to improve the feed source recovery and permeate quality of any common BWRO system, and specifically, for the upgrade of existing BWRO systems including such which are used for medical dialysis and/or other diverse reverse osmosis applications for the obtainment better quality permeates with lower energy demand.

### Example

The preferred embodiment of the inventive apparatus and method are exemplified with a system according to the design depicted in FIG. 1 comprising of a common BWRO system of the type used for Medical Dialysis (MD) with regular membrane element for Brackish Water (e.g., Net Driving Pressure (NDP) of 15 bar under Test Conditions) which is operated with 50% desalination recovery with a feed source of 400 ppm salinity supplied with flow rate of 2.5 m³/h under near atmosphere pressure. The integrated Closed Circuit Desalination Retrofit (CCDR) unit in the exemplified system is of the design depicted in FIG. 3 comprising a module (8″) with a single low energy membrane element for Brackish Water (e.g., ESPA2+) and a spacer in the length of a single element; a circulation pump (CP) with recycling flow rate of 7.1 m³/h; a Flow Meter (FM) monitor of the recycled concentrate; pressure lines (1.5″) made of SS316; Electrically Actuated Valve (AV) operated by signals received from a Conductivity Monitor (CM), and No-Return valves (NR1, NR2 and NR3) for flow control in the desired direction in the CCDR unit depicted in FIG. 3.

The exemplified CCDR unit (FIG. 3) receives a steady stream (1.25 m3/h) of fixed pressure feed (˜14 bar) of 800 ppm salinity from the BWRO unit in the system (FIG. 1) and performs a continuous two-step consecutive sequential desalination process with extended Closed Circuit Desalination intervals (˜23 minutes each) of 100% recovery and mean permeate salinity output of 14 ppm; and with brief Plug Flow Desalination intervals (˜3 minutes each) of ˜20% recovery and mean permeate salinity output of 5 ppm during which brine is discharged and the closed circuit recharged with fresh feed. This two-step consecutive sequential process manifests an over all recovery of 89% with respect to the CCDR unit in the system and the actuation the valve means AV in the unit (FIG. 3 for brine discharge initiated at an electric conductivity manifesting recycled concentrate salinity of 7,272 ppm and terminated at an electric conductivity manifesting recycled concentrate salinity of about 1,000 ppm.

Over the duration of the two-step consecutive sequence process of 26 minutes by the CCDR unit of the depicted design in FIG. 3, the feed volume demand of the BWRO unit in the system described by FIG. 1 is 1,083.3 liters of which 479.2 liters with an average salinity of ˜14 ppm originate from the CCDR unit in the system and 604.1 liters of 400 ppm salinity supplied from the external source. In simple terms, the blend supplied as feed to the BWRO unit in FIG. 1 is of an average salinity of 229.3 ppm instead of 400 PPM; therefore, the salinity of permeate supplied by the exemplified system for medical dialysis is around 2.8 ppm instead of 5.0 ppm by a common BWRO system.

The volume of discharge brine during two-step consecutive sequence of 26 minutes by the CCDR unit of the depicted design in FIG. 3 is about 50 liters, or the volume of concentrate in the closed circuit, and this implied an overall recovery of 91.7% of the external source.

1. A closed circuit desalination retrofit unit for the further desalination of pressurized brine received from a common Brackish Water Reverse Osmosis (BWRO) unit, comprising:
a closed circuit comprising one desalination module, or more than one desalination module with respective inlets and outlets connected in parallel by conducting lines, each of said desalination modules comprising one or more membrane elements; and a closed circuit conducting line with circulation means for recycling concentrate from outlets to inlets of said one or more than one desalination modules;
a conducting line for supply of said pressurized brine from said common BWRO unit to said closed circuit of said retrofit unit;
a conducting line of permeate from said retrofit unit;
a valve means in said closed circuit conducting line of said retrofit unit to enable flow from outlets to inlets of said desalination modules and for occasional discharge of brine from outlets of said desalination modules in said retrofit unit without stopping desalination;
a conducting line at outlet of said valve means to enable occasional discharge of brine from said closed circuit of said retrofit unit;
a sensor for measuring electric conductivity of recycled concentrate in said closed circuit of said retrofit unit to enable a follow up of desalination recovery in said closed circuit; and
monitoring and control systems to enable continuous closed circuit desalination of desired recovery in said retrofit unit proceed by a two-step consecutive sequential process with closed circuit desalination experienced most of the time and with occasional brine discharge and fresh feed recharge take-taking place at a desired desalination recovery level.

2. An integrated system comprising:
a brackish Water Reverse Osmosis (BWRO) unit, the BWRO unit having an inlet, a pressurized brine outlet and a permeate outlet;
a retrofit unit according to claim 1; and
a booster pump.

3. An integrated system according to claim 2, wherein said conducting line of permeate from said retrofit unit is connected to the inlet of said common BWRO unit for blending with an external feed source of said common BWRO unit.

4. (canceled)

5. An integrated system according to claim 2, wherein the conducting line of permeate from said retrofit unit is combined with permeate produced by the common BWRO unit.

6. (canceled)

7. An integrated system according to claim 2, wherein said common BWRO unit is applicable to any of the following applications: medical dialysis, high quality permeates, and for the upgrade of water supplies for domestic, industrial and agricultural applications

8. An integrated system according to claim 2, wherein said booster pump is positioned in said conducting line for supply of pressurized brine from said common BWRO unit to said closed circuit of said retrofit unit to enable pressure increase of said supply if insufficient to enable said retrofit unit reach the desired desalination recovery.

9. An integrated system according to claim 3, wherein said booster pump is positioned in said conducting line of permeate from said retrofit unit to the inlet of said common BWRO unit for blending with the external feed source to said common BWRO unit when supplied under pressure.

10. A method for further desalination of pressurized brine received from a common Brackish Water Reverse Osmosis (BWRO) unit, the BWRO unit having an inlet, a pressurized brine outlet and a permeate outlet, the method comprising:
linking a retrofit unit according to claim 1 to said common BWRO unit by a conducting line such that the entire pressurized brine effluent of the BWRO unit becomes the feed of the retrofit unit.

11. A method of claim 10 wherein permeate from the retrofit unit constitutes part of the feed to the BWRO unit.

12. A method of claim 10 wherein permeates of said retrofit unit and said common BWRO unit are combined.
